(19) United States
(12) Patent Application Publication
(10) Pub. No.: US 2019/0243378 A1
(43) Pub. Date: Aug. 8, 2019

(54) RADAR-BASED GUIDANCE AND WIRELESS CONTROL FOR AUTOMATED VEHICLE PLATOONING AND LANE KEEPING ON AN AUTOMATED HIGHWAY SYSTEM

(71) Applicant: SURYA SATYAVOLU, novato, CA (US)

(72) Inventor: SURYA SATYAVOLU, novato, CA (US)

(21) Appl. No.: 15/854,337

(22) Filed: Dec. 26, 2017

Related U.S. Application Data
(63) Continuation-in-part of application No. 15/197,750, filed on Jun. 29, 2016, now abandoned.
(60) Provisional application No. 62/187,418, filed on Jul. 1, 2015.

(51) Int. Cl. G05D 1/02; G05D 1/00; G01C 21/34; G01S 13/93; H01Q 15/18

(52) U.S. Cl. CPC G05D 1/0257; G05D 1/0088; G05D 1/0223; G05D 1/0293; G01C 21/3438; G01S 2013/0245; H01Q 15/18; G05D 2201/0213; G01S 2013/9375; G01S 2013/9385; G01S 13/931

(57) ABSTRACT

A computerized system onboard a vehicle for automatic radar-based vehicle guidance includes a front-looking radar sensing module. The front-looking radar sensing module comprises a pair of radar sensors. The pair of radar sensors are placed at front of vehicle. The pair of radar sensors emits radar waves at a specified radar frequency and senses reflected radar waves. The radar waves are reflected by a set of radar reflectors placed at the side of a roadway at a distance ahead of the vehicle on the roadway. The front-looking radar sensing module obtains a reflected-radar information from the pair of radar sensors and determines the distance between the vehicle and the radar reflectors ahead of the vehicle at a specified time.

### CROSS-REFERENCE TO RELATED APPLICATIONS

This application is a claims priority to U.S. patent application Ser. No. 15/197,750, titled Radar-Based Guidance and Wireless Control For Automated Vehicle Platooning And Lane Keeping On An Automated Highway System and filed on Jun. 29, 2016. U.S. patent application Ser. No. 15/197,750 claims priority to U.S. provisional patent application No. 62/187,418, titled Radar Based Guidance and Wireless Control for Platooning and Lane Keeping on an Automated Highway System and filed on Jul. 1, 2015. These applications are hereby incorporated by reference in their entirety.

### BACKGROUND

The current lane keeping systems make use of vision based camera systems with painted lane separation markers. These systems cannot provide the necessary reliability and functional safety assurance for an automated highway. For example, in a platooning content, the current solutions may fail to provide the reliable lateral and longitudinal guidance with heterogeneous vehicles for forming dynamic platoons. It is further noted that computer vision-based systems can suffer in bad weather conditions and not provide reliable guidance with lane keeping and platooning situations. Accordingly, improvements to automated vehicle platooning and lane keeping are desired.

### BRIEF SUMMARY OF THE INVENTION

In one aspect, a computerized system onboard a vehicle for automatic radar-based vehicle guidance includes a front-looking radar sensing module, wherein the front-looking radar sensing module comprises a pair of radar sensors. The pair of radar sensors are placed at the front of the vehicle. The pair of radar sensors emits radar waves at a specified radar frequency and senses reflected radar waves. The radar waves are reflected by a set of radar reflectors placed at the side of a roadway at a distance ahead of the vehicle on the roadway. The front-looking radar sensing module obtains a reflected-radar information from the pair of radar sensors and determines the distance between the vehicle and the radar reflectors ahead of the vehicle at a specified time. Reflectors can run perpendicular to the radar beam.

The computerized system includes a side-looking radar sensing module comprising a first side-facing radar sensor placed on one side of the vehicle and a second side-facing radar sensor placed on the other side of the vehicle. The first side-facing radar sensor emits radar waves at the specified radar frequency and senses reflected radar waves from the set of radar reflectors at one side of a roadway lateral to the vehicle. The second side-facing radar sensor emits radar waves at the specified radar frequency and senses reflected radar waves from the set of radar reflectors at the other side of a roadway lateral to the vehicle. The side-looking radar sensing module uses a reflected-radar information from the first side-facing radar sensor and the second side-facing radar sensor to determine a position of the vehicle in the roadway with respect to the edges of the roadway at the specified time.

The computerized system includes a path-planning module. The path-planning module obtains the position of the vehicle in the roadway with respect to the edges of the roadway information from side-looking radar sensing module and the distance between the vehicle and the radar reflectors ahead of the vehicle and provides a path for the vehicle.

The computerized system includes a trajectory-tracking module. The trajectory-tracking module wherein the path-planning module obtains the position of the vehicle in the roadway with respect to the edges of the roadway information from side-looking radar sensing module and the distance between the vehicle and the radar reflectors ahead of the vehicle. The trajectory-tracking module determines a vehicle's current trajectory. Trajectory can be adjusted based on the new inputs.

The computerized system includes a vehicle-dynamics controller. The vehicle-dynamic controller manages a set of vehicle dynamics to implement the path provided by the path-planning module.

The computerized system can include a set of radar reflectors is placed perpendicular to a line of sight for both the pair of radar reflectors designed for squint-facing radar and the other pair of radar reflectors designed for side-looking radar. The set of radar reflectors can include a pair of radar reflectors designed for squint-facing radar and another pair of radar reflectors designed for side-looking radar of the side-looking radar sensing module. The set of radar reflectors can be placed along the roadway with a spacing of five to ten meters and provides a guided pathway.

### BRIEF DESCRIPTION OF THE DRAWINGS

The present application can be best understood by reference to the following description taken in conjunction with the accompanying figures, in which like parts may be referred to by like numerals.

FIG. 1 illustrates an example radar-based guidance and wireless control system 100, according to some embodiments.

FIG. 2 illustrates an example set of modes for an on-board vehicle guidance system, according to some embodiments.

FIG. 3 illustrates an example process for path planning, according to some embodiments.

FIG. 4 illustrates an example process of transitioning into a platoon initiation mode, according to some embodiments.

FIG. 5 illustrates an example process for automatic vehicle platooning, according to some embodiments.

FIG. 6 illustrates an example process for automatic vehicle lane keeping on an automated highway system, according to some embodiments.

FIG. 7 illustrates and example system for radar-based guidance and wireless control for automatic vehicle platooning and lane keeping on an automated highway system, according to some embodiments.

FIG. 8 depicts an exemplary computing system that can be configured to perform any one of the processes provided herein.

FIG. 9 Illustrates an example block diagram of an MPC system, according to some embodiments.

FIG. 10 illustrates process of a key method of MPC Algorithm, according to some embodiments.

The Figures described above are a representative set, and are not an exhaustive with respect to embodying the invention.

### DETAILED DESCRIPTION

Disclosed are a radar-based guidance and wireless control for automatic vehicle platooning and lane keeping on an automated highway system. Although the present embodiments have been described with reference to specific example embodiments, it can be evident that various modifications and changes may be made to these embodiments without departing from the broader spirit and scope of the particular example embodiment.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, attendee selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labelled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Example Definitions

Model predictive control (MPC) is an advanced method of process control. Model predictive controllers can use dynamic models of process, (e.g. linear empirical models obtained by system identification, etc.). An MPC can enable the current timeslot to be optimized, while keeping future timeslots in account. This can be achieved by optimizing a finite time-horizon, and/or implementing the current timeslot and then optimizing again.

Path can be a road, highway, rail system, runway, boat route, bike path, etc., according to various embodiments.

Phased array can be an array of antennas in which the relative phases of the respective signals feeding the antennas are set in such a way that the effective radiation pattern of the array is reinforced in a desired direction and suppressed in undesired directions.

Platooning can be a method of grouping vehicles into platoons as a way of increasing the capacity of roads. Vehicle platoons can decrease the distances between vehicles (e.g. cars, trucks, etc.) a coupling system. This capability can enable vehicles to turn, accelerate and/or brake substantially simultaneously (e.g. assuming networking and/or processing latencies). Platooning can enable for a closer headway between vehicles by eliminating reacting distance needed for human reaction.

Radar is an object-detection system that uses radio waves to determine the range, angle, or velocity of objects.

Radar cross-section (RCS) is a measure of how detectable an object is with radar.

Vehicle can be a mobile machine (e.g. transports people or cargo). Typical vehicles can include wagons, bicycles, motor vehicles (e.g. motorcycles, cars, trucks, buses), railed vehicles (e.g. trains, trams), watercraft (e.g. ships, boats), aircraft and/or spacecraft.

Vehicle dynamics refers to the dynamics of vehicles. Components, attributes or aspects of vehicle dynamics include, inter alia: automobile layout, electronic stability control (ESC), steering, suspension, traction control system (TCS), etc. Vehicle dynamics system can also include vehicle control handing and roadway analysis systems.

### Example Systems and Methods

An example system can use millimeter wave-phased array radar to achieve the improved weather accuracy and precision used for automatic lane keeping, homing guidance and/or rendezvous maintenance. An example radar-based guidance and wireless control systems for platooning and lane keeping on an automated highway system is now provided. The system can provide reliable touch-free guidance and/or control used for an automated highway system.

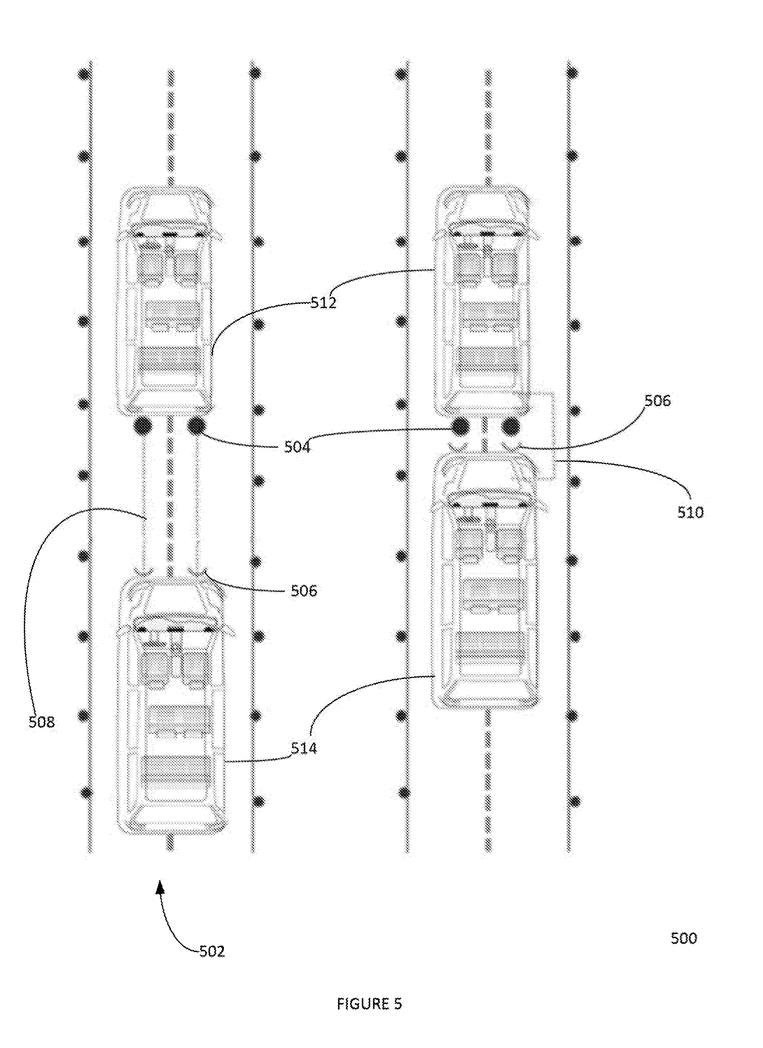

The system can use millimeter wave phased array radars augmented with reflectors placed along a pathway (e.g. a highway, a road, a path, a runway, etc.) to implement stable and reliable lane-keeping guidance. The reflectors can be placed at the back of a lead-vehicle (e.g. see FIG. 5 Infra) as markers for homing guidance and achieving a stable rendezvous for dynamic platooning. The system can use of vehicle-to-vehicle wireless control to implement vehicle-to-vehicle communications. The reflectors can be high RCS radar reflectors.

Millimeter wave-phased array radar system can be integrated into vehicles to obtain information used for lane-keeping, homing guidance and/or rendezvous maintenance. Additionally, present systems can include on-board vehicle guidance software for an automated highway system and an automated control system for wireless control of vehicular traffic on said automated highway.

Automated highway system can include a series of radar reflectors. The series of radar reflectors can be placed at specified intervals on both sides of a path such as a roadway for vehicles. Radar reflectors can be RCS radar reflectors. The shape, composition, angles, surfaces, etc. of the radar reflectors can be optimized to reflect a specified radar frequency that is detectable by radar sensors in a radar system of a vehicle (e.g. front-looking radar sensors, side-looking radar sensors, etc.). In one example, the angles of the radar reflectors can be designed for a high probability of detection.

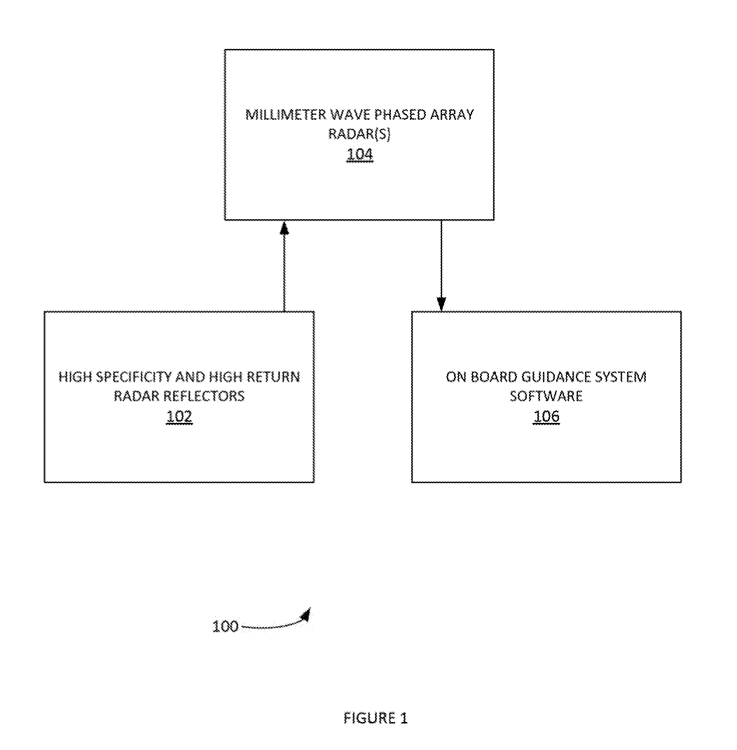

FIG. 1 Illustrates an example radar-based guidance and wireless control system 100, according to some embodiments. System 100 can be used for vehicle platooning and lane keeping on an automated highway system. System 100 can include radar reflectors 102. Radar reflectors 102 can be designed for high specificity and high return. For example, radar reflectors can be designed to reflect the millimeter wave-phased array radar waves emitted by millimeter wave-phased array radar (MWPAR) system(s) 104 back toward the radar antenna. In some examples, the reflectors can be placed (e.g. in a series at specified distance intervals) along each side of the roadway to form a guided pathway. Two reflectors with a fixed horizontal separation can also be placed on the back of the vehicle for lateral and longitudinal guidance in platooning mode (e.g. see infro).

System 100 can include MWPAR systems 104. MWPAR system 104 can include millimeter-wave radar sensor technology for guiding a vehicle along a specified path. In one example, MWPAR system 104 can be integrated into a vehicle as follows. Two-phased array radars with directional beam forming capabilities are placed on each side of the vehicle in side-looking position. One array-radar can be placed in a perpendicular position to the vehicle's x-axis and another array radar can be placed at an acute angle with the vehicle's x-axis. Additionally, two more front facing millimeter wave phased array radars with beam forming and beam steering capabilities can also be placed on the vehicle.

MWPAR system 104 can use a phased array beam-forming antenna with a reflector with optimal RCS for high-detection probability. In one example, a trihedral cubic corner reflector with frequency selective surface grating can be used. Frequency selective surfacing can act as a band pass filter admitting on frequencies within the operating band of the radar. This can minimize false alarms. In one example, squint-looking radars can be placed at an angle with the vehicle of about twenty-two point five plus or minus seven point five degrees (22.5±7.5 degrees). This can provide sufficient forward horizon (e.g. when road curvature is limited to about five (5) degrees). A pair of reflectors one for squint-facing radar, and one for side looking radar, can be placed along the roadside with a spacing of five to ten meters (5-10 m) to provide a guided pathway. The reflectors can be placed perpendicular to the radar's line of sight both for the squint looking as well as the side looking radars. In one example, the radars can be placed next to the headlights towards the front side of the vehicle. The squint-looking radars can be looking at an angle rather than straight.

The two front facing radars used for platooning guidance would have beam steering antenna with a beam that can be steered by at least ten (10) degrees from the broadside. The beam steering capabilities can be used to search and detect the corresponding reflector placed on the target vehicle's backside.

System 100 can include on-board guidance system software 106. On-board guidance system software 106 can obtain the path information from MWPAR system 104 can control a vehicle's steering, breaking, speed, etc. In this way, on-board guidance system software 106 can navigate the vehicle along a path at a specified speed and/or vehicle-platooning configuration. On-board guidance system software 106 can provide the guidance system for lane keeping guidance and homing and terminal rendezvous guidance for platooning.

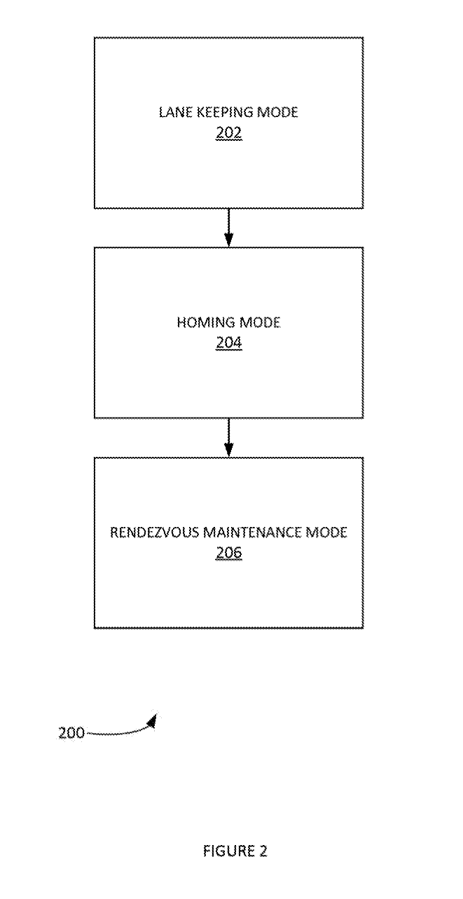

FIG. 2 Illustrates an example set of modes 200 for an on-board vehicle guidance system, according to some embodiments. For example, a vehicle guidance system can operate in three (3) distinct modes (e.g. depending on the guidance laws). Set of modes 200 can include a lane-keeping mode 202. In lane-keeping mode 202, a vehicle can use the sensory information from the side-looking radar systems (e.g. such as those provided in MWPAR system 104 supro) to maintain the vehicle within a lane of a path while continuing to move at a specified speed. It is noted that the specified speed can be set via a roadside infrastructure communications unit. This can be implement using path planning, trajectory generation and/or tracking as explained infra. The roadside communications unit can have additional speed sensors placed along the roadside to enforce a speed zone authority and automatic speed protection. The speed sensors that are placed along the roadside can detect the speed of the vehicles. If the speed is not within the recommended speed range for the zone, the roadside communication unit can send a command to the vehicle's on-board computer to Increase or decrease the speed. This command can have a degree if severity ranging from advisory to emergency fails-safe braking depending on the response and subsequent speed sensing from the sensors in the zone. If, by the end of authority (e.g. when the last speed sensor is reached), the vehicle does not obtain within the recommended speed, an emergency signal can be raised to bring the vehicle or platoon to a fail-safe stop.

Set of modes 200 can include a homing mode 204. In the homing mode 204, the guidance law can be implemented. The guidance law can instruct vehicles to reduce a distance between the vehicles while tracking and aligning each of the front-facing radars (e.g. such as those provided in MWPAR system 104 supra) to the rear reflectors of a respective lead vehicle. This is done with a terminal condition of rendezvous with the vehicle ahead at a pre-set inter-vehicle gap. Once rendezvous is established, the vehicle-to-vehicle wireless control link can be established, and control is ceded to the lead vehicle's guidance system.

Set of modes 200 can Include a rendezvous maintenance mode 206. In the rendezvous maintenance mode 206, the guidance system in the following vehicle can be deactivated. The control system can be guided by the control commands from the respective lead vehicle (e.g. as provided via the vehicle-to-vehicle wireless control link between the two vehicles, etc.). The following vehicle can continue to communicate instantaneous (e.g. assuming networking and/or processing latency) inter-vehicle gap information periodically so that rendezvous maintenance mode 206 can be maintained.

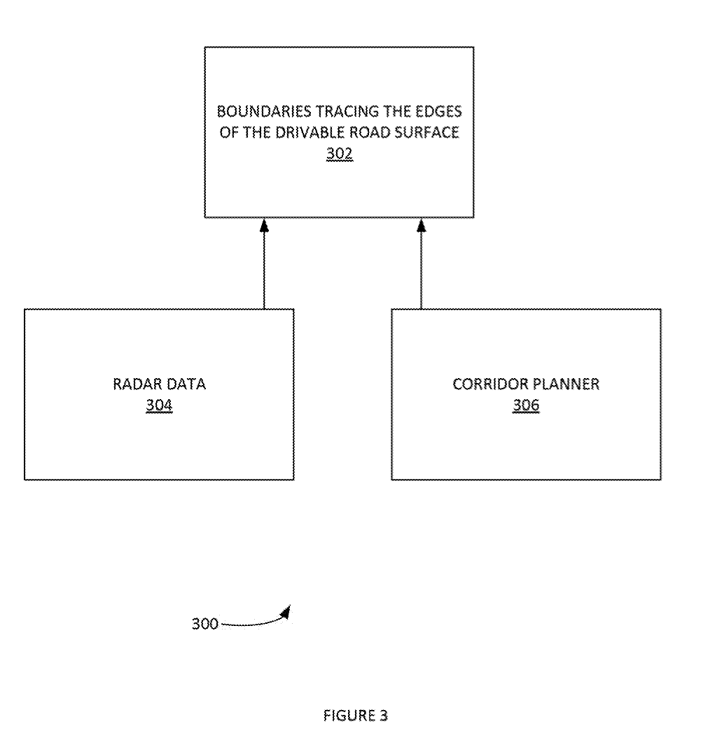

FIG. 3 illustrates an example process 300 for path planning, according to some embodiments. Process 300 can use a model predictive controller to perform predictive trajectory planning with constraints for safe or optimal path generated from side looking radar data. Process 300 can determine boundaries tracing the edges of the drivable road surface in step 302. Step 302 can obtain the radar data 304 and a corridor planner data 306. This information can be used to calculate the boundaries tracing the edges of the drivable road surface. These boundaries can be used to establish constraints on the vehicle's projected position. This constraint data, together with a model of the vehicle dynamics, can then be used to calculate an optimal sequence of inputs and the associated vehicle trajectory. The predicted trajectory can be assumed to be the best-case scenario in the absence of a lead vehicle that limits the look-ahead horizon. If a lead vehicle has been detected, the guidance system can transfer into platoon initiation mode.

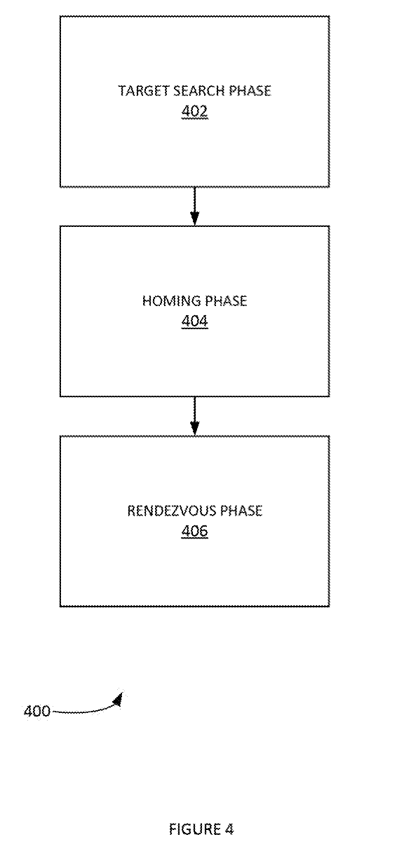

FIG. 4 illustrates an example process 400 of transitioning into a platoon initiation mode, according to some embodiments. Process 400 can include three (3) phases depending on the guidance model applicable in each phase. In step 402, process 400 can implement a target-search phase. As the vehicle is moving through the pathway whenever the front facing radar detects a potential platoon target as an obstacle, a search can be initiated by each of the front facing radar to try and detect the corresponding reflector and lock into it. The beam steering capabilities of the phased array radar help in the search.

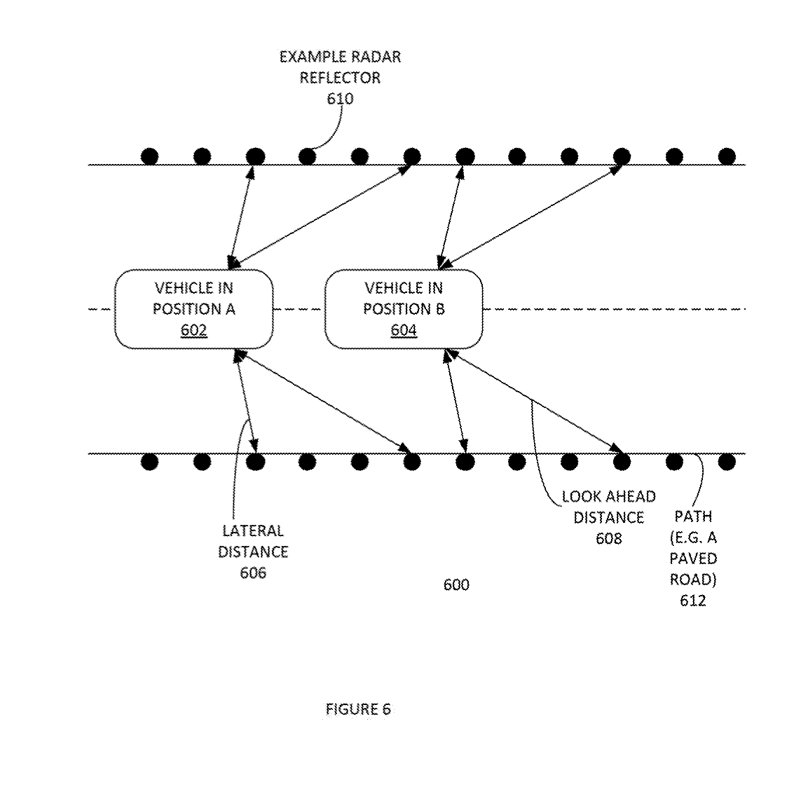

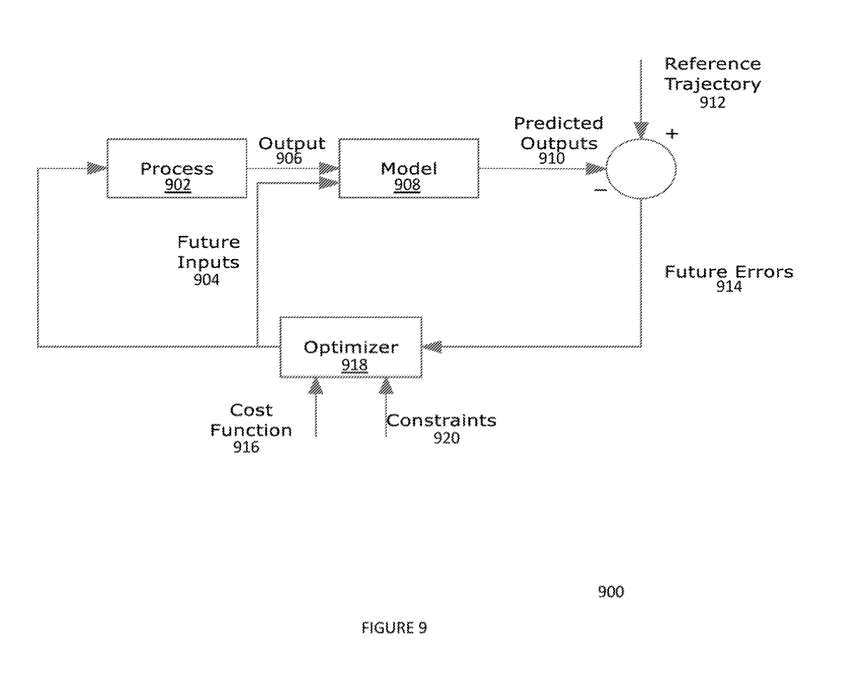

In step 404, process 400 can include a homing phase. Once the radars lock to their respective targets, homing phase step 402 can be initiated. The guidance system can be placed homing mode (e.g. as provided supra). During the homing mode, the guidance system can utilize a range of information obtained from the front facing radar systems. The path planning and trajectory generation and tracking (e.g. see supra) can still be used for automatic vehicle navigation. However, the look-ahead horizon (e.g. see FIGS. 5 and 6 Infra) can be truncated to the lead vehicle's position. Further rendezvous constraints can be added to the model predictive controller to achieve the rendezvous at a pre-set inter-vehicle platooning gap. Vehicle dynamics can be controlled using Model Predictive Control (MPC) (e.g. see FIG. 9 infra) to track the planned path. MPC can be a finite-horizon optimal control scheme that iteratively minimizes a performance objective defined for a forward-simulated plant model subject to performance and input constraints. In one example, MPC can use a model of the plant to predict future vehicle state evolution and optimize a set of inputs such that this prediction satisfies constraints and minimizes a system-defined objective function. The open-loop optimal control problem can be used to minimize the deviations of the predicted outputs from their references over a sequence of trajectory points (e.g. subject to operating constraints). In the case of a rendezvous operation, an inter-vehicle gap and speed matching can be specified as additional constraints while planning a speed and acceleration profile for achieving the rendezvous at the set gap.

In step 406, process 400 can implement a rendezvous phase. Once the rendezvous is achieved at the desired inter-vehicle gap, the vehicle-to-vehicle wireless control link is established. Control of the vehicle's automatic navigation can then be ceded to the lead vehicle while communicating the instantaneous (e.g. assuming networking and/or processing latency) inter-vehicle gap information periodically to the lead vehicle. The inter vehicle gap can be set depending on the speed and efficiency requirements based on traffic conditions. Under peak traffic, a goal can be to minimize the gap as much as possible without compromising on the reliability of the rendezvous. In some examples, a gap of one to five (1-5) meters can be achievable at speeds up to one-hundred and twenty miles-per-hour (120 mph).

FIG. 5 illustrates an example process 500 for automatic vehicle platooning, according to some embodiments. Process 500 can include two vehicles travelling on automated highway system 502. Automated highway system 502 can include a series of radar reflectors placed at specified intervals on each side of a highway lane. A lead-vehicle 512 can include rear-facing radar reflectors 504. The rear-facing radar reflectors 504 can be detected by the front-facing radar system 506 of a following vehicle 514. Radar data can be used to determine a distance 508 between lead-vehicle 512 and following vehicle 514. The automated vehicle guidance systems of lead-vehicle 512 and following vehicle 514 can couple via a wireless network. The navigation of the following vehicle 514 can synchronize with lead vehicle 512. A second platooning distance 510 can be managed between lead-vehicle 512 and following vehicle 514. The platooning distance 510 can be set based on such factors as, inter alia: safety, traffic patterns, highway 502 conditions, etc. For example, platooning distance 510 can be decreased during high-traffic periods. In another example, platooning distance 510 can be increased during poor weather conditions. In one example, platooning distance 510 can be increased when lead-vehicle 512 and following vehicle 514 are travelling at a high speed (and decreased when lead-vehicle 512 and following vehicle 514 are travelling at a low speed). In one example, a user of either vehicle can also curate platooning distance 510 instructions.

FIG. 6 illustrates an example process 600 for automatic vehicle lane keeping on an automated highway system, according to some embodiments. A vehicle is shown in two different positions: position A 602 and position B 604 on a path 612 (e.g. a paved road). Path 612 can include a series of radar reflectors placed at specified intervals on each side of a highway lane (e.g. Includes example radar reflector 610). The vehicle can include both front-facing and side-facing radar systems. FIG. 6 illustrates that the front-facing and side-facing radar systems can detect different radar reflectors in the series position A 602 then in position B 604. Each radar reflector can be detected in series. The radar reflectors can provide the vehicle positional information with respect to path 612. The time period between detections can used to periodically reset the on-board automatic vehicle guidance parameters (e.g. direction, speed, breaking, platooning distance, etc.) based on the position Information.

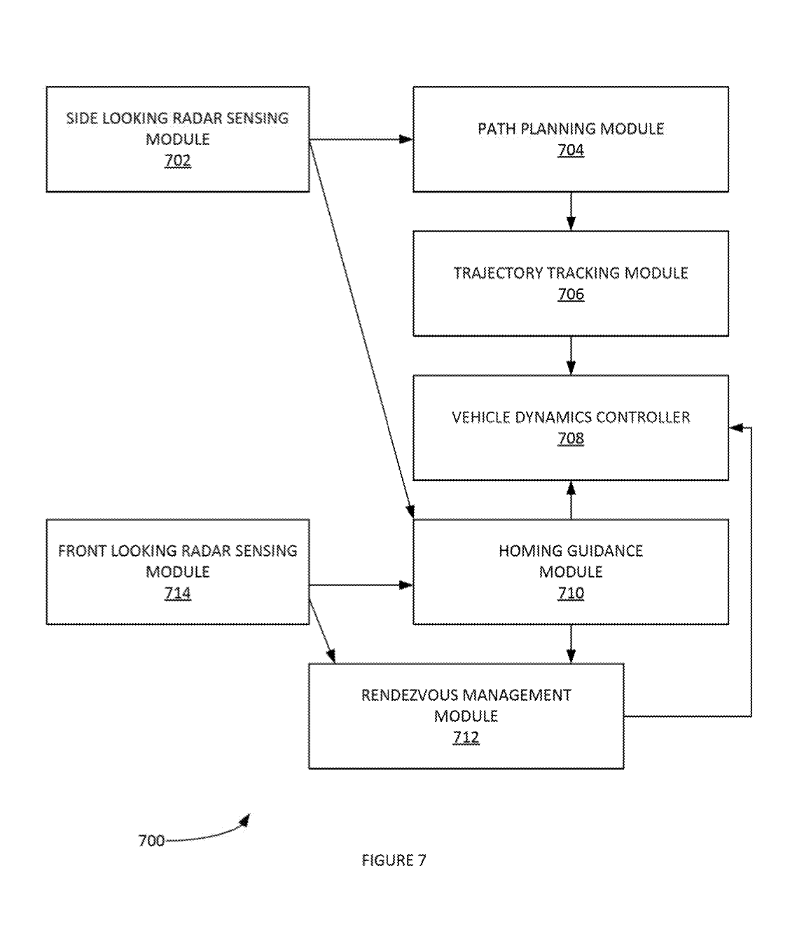

FIG. 7 illustrates and example system 700 for radar-based guidance and wireless control for automatic vehicle platooning and lane keeping on an automated highway system, according to some embodiments. System 700 can include side-looking radar sensing module 702. Side-looking radar sensing module 702 can emit radar waves and sense reflected radar waves (e.g. within a specified frequency range). Side-looking radar sensing module 702 can be installed on the sides of a vehicle. Side-looking radar sensing module 702 can obtain information for determining a distance between the vehicle and the radar reflectors at a specified time.

Information from side-looking radar sensing module 702 can be sent to various modules of system 700. For example, path-planning module 704 can use the information from side-looking radar sensing module 702 to plan a path for the vehicle. Trajectory tracking module 706 can determine a vehicle's current trajectory. Trajectory tracking module 706 can determine whether the current trajectory of a vehicle is off of a path set by path-planning module 704.

Vehicle dynamics controller 708 can control/manage various vehicle dynamics (e.g. speed, braking systems, steering systems, acceleration systems, etc.). Homing guidance module 710 can control/manage a homing mode as provided supra. Homing guidance module 710 can manage the guidance and achieving a stable rendezvous for dynamic platooning.

Rendezvous management module 712 can manage rendezvous operations as provided supro. Rendezvous management module 712 can maintain a constant speed between vehicles in a platooning mode. Rendezvous management module 712 can obtain information (e.g. via a wireless network) from a lead vehicle while a following vehicle is in platooning mode. In one example, if a lead vehicle changes its speed, rendezvous management module 712 can cause the following vehicle to change its speed in a proportional manner without causing changes in a gap between the two vehicles.

Front looking radar sensing module 714 can include can emit radar waves and sense reflected radar waves (e.g. within a specified frequency range). Front looking radar sensing module 714 can be installed on the front of a vehicle. Information from front looking radar-sensing module 714 can be sent to various modules of system 700. Front looking radar sensing module 714 can detect radar reflectors at the side of a path/road. Front looking radar sensing module 714 can obtain information for determining a distance between the vehicle and the radar reflectors at a specified time.

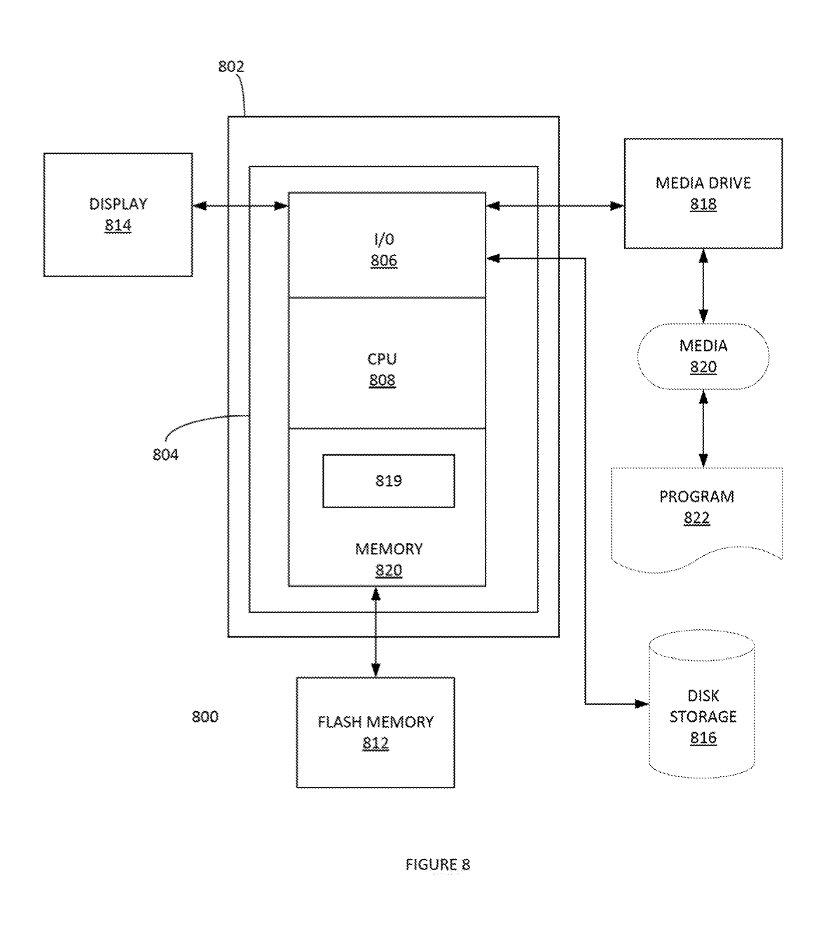

FIG. 8 depicts an exemplary computing system 800 that can be configured to perform any one of the processes provided herein. In this context, computing system 800 may include, for example, a processor, memory, storage, and I/O devices (e.g., monitor, keyboard, disk drive, Internet connection, etc.). However, computing system 800 may include circuitry or other specialized hardware for carrying out some or all aspects of the processes. In some operational settings, computing system 800 may be configured as a system that includes one or more units, each of which is configured to carry out some aspects of the processes either in software, hardware, or some combination thereof.

FIG. 8 depicts computing system 800 with a number of components that may be used to perform any of the processes described herein. The main system 802 includes a mother-board 804 having an I/O section 806, one or more central processing units (CPU) 808, and a memory section 810, which may have a flash memory card 812 related to it. The I/O section 806 can be connected to a display 814, a keyboard and/or other user input (not shown), a disk storage unit 816, and a media drive unit 818. The media drive unit 818 can read/write a computer-readable medium 820, which can include programs 822 and/or data. In some embodiments, parts or all of system 800 can be implemented in a cloud-computing environment.

FIG. 9 illustrates an example block diagram of an MPC system 900, according to some embodiments. The vehicle Dynamics controller can include an MPC algorithm which uses a vehicle dynamics model and optimizes the evolution of the state over a finite horizon using an open loop feed forward control with constraints. It can be implemented as software on a microprocessor. Process 902 can generate outputs 906. Outputs 906 and future inputs 904 can be fed into model 908. Model 908 can generate predicted outputs 910. Predicted outputs 910 and reference trajectory 912 can be used to provide future errors 914. Future errors 914, cost function 916 and constraints 920 can be provided to optimizer 918.

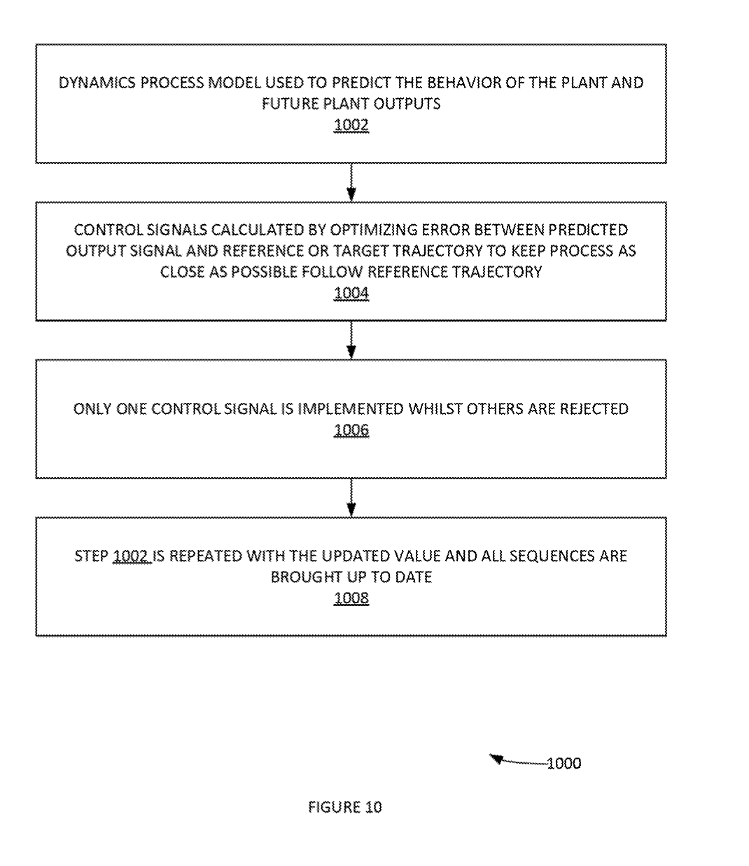

FIG. 10 illustrates process 1000 of a key method of Model Predictive Control Algorithm, according to some embodiments. An example of a key method of Model Predictive Control Algorithm can be described as follows. In step 1002, a dynamics process model is used to predict the behavior of the plant and future plant outputs, y(k+i|k) for i=1, 2, . . . , Hp, for a determined prediction horizon, Hp, at each instant k based on past and current inputs and outputs measurements up to instant k, and on the future control signal, u(k+i|k), i=0, 1, . . . , Hc−1, where He is called control horizon.

In step 1004, these control signals, u(k+i|k) are calculated by optimizing the error between the predicted output signal and reference or target trajectory to keep the process as close as possible follow the reference trajectory, r(k+i|k). The objective function and all constraints are considered in many cases.

In step 1006, only one control signal, u(k|k) is implemented on the plant whilst others are rejected, due to the next sampling instant, y(k+1) is known.

In step 1008, step 1002 is repeated with the updated value and all sequences are brought up to date. The radar measurements and the sensing of internal sensors provide the inputs for determining the current state of the system. The trajectory to be followed is calculated by the path planning module from the radar measurements. It is implemented as software with optimizations performed to the specific hardware to meet the real-time performance requirements of the system.

Additional ideas that can be implemented in some example embodiments are now discussed. It is noted that the line passing through the middle of the vehicle from front to back is the x-axis of the vehicle and is at a zero-degree angle. The antenna bore-sight of the radar can make an angle of 45 degrees to the x-axis. Reflectors can run perpendicular to the radar beam. In one example, the front-looking radar sensing module can include a pair of radar sensors. The side-looking radar sensing module can include a pair of radar sensors, as disclosed in paragraph. The path-planning module can include a software module within a computing system. The trajectory-tracking module can include a software module within a computing system.

A rendezvous management module can manage rendezvous operations with a lead vehicle, wherein the rendezvous operation comprises the rendezvous management module maintaining a fixed gap within requisite tolerances between the vehicle and the vehicle ahead when in a platooning mode by obtaining a set of lead vehicle dynamics information via a wireless network between the vehicle and the lead vehicle following the lead vehicle in a platooning mode. A homing-guidance module can manage a stable rendezvous for dynamic vehicle platooning between the vehicle and the lead vehicle.

### B. CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized system of onboard a vehicle for automatic radar-based vehicle guidance comprising:
a front-looking radar sensing module, wherein the front-looking radar sensing module comprises a pair of radar sensors, wherein the pair of radar sensors are placed at the front of the vehicle, wherein the pair of radar sensors emits radar waves at a specified radar frequency and senses reflected radar waves, wherein the radar waves are reflected by a set of radar reflectors placed at the side of a roadway at a distance ahead of the vehicle on the roadway, and wherein the front-looking radar sensing module obtains a reflected-radar information from the pair of radar sensors and determines the distance between the vehicle and the radar reflectors ahead of the vehicle at a specified time;
a side-looking radar sensing module comprising a first side-facing radar sensor placed on one side of the vehicle and a second side-facing radar sensor placed on the other side of the vehicle, wherein the first side-facing radar sensor emits radar waves at the specified radar frequency and senses reflected radar waves from the set of radar reflectors at one side of a roadway lateral to the vehicle, wherein the second side-facing radar sensor emits radar waves at the specified radar frequency and senses reflected radar waves from the set of radar reflectors at the other side of a roadway lateral to the vehicle, and wherein the side-looking radar sensing module uses a reflected-radar information from the first side-facing radar sensor and the second side-facing radar sensor to determine a position of the vehicle in the roadway with respect to the edges of the roadway at the specified time;
a path-planning module, wherein the path-planning module obtains the position of the vehicle in the roadway with respect to the edges of the roadway information from side-looking radar sensing module and the distance between the vehicle and the radar reflectors ahead of the vehicle and provides a path for the vehicle;
a trajectory-tracking module, wherein the trajectory-tracking module wherein the path-planning module obtains the position of the vehicle in the roadway with respect to the edges of the roadway information from side-looking radar sensing module and the distance between the vehicle and the radar reflectors ahead of the vehicle, and wherein the trajectory-tracking module determines a vehicle's current trajectory; and
a vehicle-dynamics controller, wherein the vehicle-dynamic controller manages a set of vehicle dynamics to implement the path provided by the path-planning module.

2. The computerized system of claim 1, wherein the pair of radar sensors comprises a phased array beam-forming antenna.

3. The computerized system of claim 2, wherein the pair of radar sensors comprise a millimeter wave-phased array radar system.

4. The computerized system of claim 3, wherein the set of radar reflectors comprises a set of radar cross section (RCS) radar reflectors with a specified RCS shape for a high-detection probability with respect to the specified radar frequency of the pair of radar sensors.

5. The computerized system of claim 4, wherein the set of radar reflectors comprises a trihedral cubic corner reflector with a frequency selective surface grating selected for the specified radar frequency of the pair of radar sensors.

6. The computerized system of claim 5, wherein the pair of radar sensors comprises a pair of squint-looking radars placed at an angle with the vehicle of twenty-two point five plus or minus seven point five degrees.

7. The computerized system of claim 6, wherein the set of radar reflectors comprises a pair of radar reflectors designed for squint-facing radar and another pair of radar reflectors designed for side-looking radar of the side-looking radar sensing module.

8. The computerized systems of claim 7, wherein the set of radar reflectors is placed along the roadway with a spacing of five to ten meters and provides a guided pathway.

9. The computerized system of claim 8, wherein the set of radar reflectors is placed perpendicular to a line of sight for both the pair of radar reflectors designed for squint-facing radar and the other pair of radar reflectors designed for side-looking radar.

10. The computerized system of claim 9, wherein the trajectory-tracking module determines that the current trajectory of a vehicle is off of a path set by path-planning module and notifies the path-planning module to adjust the path of the vehicle.

11. The computerized system of claim 10, wherein the set of vehicle dynamics comprises a vehicle speed value, a vehicle braking value, a vehicle steering value, and a vehicle acceleration value.

12. The computerized system of claim 11 further comprising:
a rendezvous management module, wherein the rendezvous management module manages rendezvous operations with a lead vehicle, wherein the rendezvous operation comprises the rendezvous management module maintaining a constant speed between the vehicle and the vehicle in a platooning mode by obtaining a set of lead vehicle dynamics information via a wireless network between the vehicle and the lead vehicle following the lead vehicle in a platooning mode.

13. The computerized system of claim 12 further comprising:
a homing-guidance module, wherein homing-guidance module manages a stable rendezvous for dynamic vehicle platooning between the vehicle and the lead vehicle.

14. A computerized system of onboard a vehicle for automatic radar-based vehicle guidance comprising:
a front-looking radar sensing module, wherein the front-looking radar sensing module comprises a pair of radar sensors, wherein the pair of radar sensors are placed at the front of the vehicle, wherein the pair of radar sensors emits radar waves at a specified radar frequency and senses reflected radar waves, wherein the radar waves are reflected by a set of radar reflectors placed at the side of a roadway at a distance ahead of the vehicle on the roadway, and wherein the front-looking radar sensing module obtains a reflected-radar information from the pair of radar sensors and determines the distance between the vehicle and the radar reflectors ahead of the vehicle at a specified time;
a side-looking radar sensing module comprising a first side-facing radar sensor placed on one side of the vehicle and a second side-facing radar sensor placed on the other side of the vehicle, wherein the first side-facing radar sensor emits radar waves at the specified radar frequency and senses reflected radar waves from the set of radar reflectors at one side of a roadway lateral to the vehicle, wherein the second side-facing radar sensor emits radar waves at the specified radar frequency and senses reflected radar waves from the set of radar reflectors at the other side of a roadway lateral to the vehicle, and wherein the side-looking radar sensing module uses a reflected-radar information from the first side-facing radar sensor and the second side-facing radar sensor to determine a position of the vehicle in the roadway with respect to the edges of the roadway at the specified time;
a path-planning module, wherein the path-planning module obtains the position of the vehicle in the roadway with respect to the edges of the roadway information from side-looking radar sensing module and the distance between the vehicle and the radar reflectors ahead of the vehicle and provides a path for the vehicle;
a trajectory-tracking module, wherein the trajectory-tracking module wherein the path-planning module obtains the position of the vehicle in the roadway with respect to the edges of the roadway information from side-looking radar sensing module and the distance between the vehicle and the radar reflectors ahead of the vehicle, and wherein the trajectory-tracking module determines a vehicle's current trajectory; and
a vehicle-dynamics controller, wherein the vehicle-dynamic controller manages a set of vehicle dynamics to implement the path provided by the path-planning module,
wherein the set of radar reflectors comprises a pair of radar reflectors designed for squint-facing radar and another pair of radar reflectors designed for side-looking radar of the side-looking radar sensing module, and
wherein the set of radar reflectors is placed along the roadway with a spacing of five to ten meters and provides a guided pathway.
